(19) United States
(12) Patent Application Publication
(10) Pub. No.: US 2026/0218408 A1
(43) Pub. Date: Jul. 30, 2026

(54) ELECTROPOLISHING PROCESS FOR INTERNAL SURFACES OF AM PARTS

(71) Applicant: Divergent Technologies, Inc., Los Angeles, CA (US)

(72) Inventors: Michael Thomas Kenworthy, Rancho Palos Verdes, CA (US); Bahram Issari, Laguna Niguel, CA (US)

(73) Assignee: Divergent Technologies, Inc., Los Angeles, CA (US)

(21) Appl. No.: 19/460,077

(22) Filed: Jan. 26, 2026

Related U.S. Application Data
(60) Provisional application No. 63/749,429, filed on Jan. 24, 2025.

(51) Int. Cl. C25F 3/16; B33Y 40/20

(52) U.S. Cl. CPC C25F 3/16; B33Y 40/20

(57) ABSTRACT

A method for electropolishing and electroplating surfaces of structures. The method includes placing a first material within an internal volume of the structure, shrinking the first material such that a gap is formed between the first material and a surface of the structure, and applying a voltage across the gap. The first material may coat the inner surface or a portion of the inner surface of structure. The method may optionally include applying a second material to the surface of the structure such that the second material contacts the first material and the first material separates from the second material when shrinking of the first material. The method may include controlling the gap by coupling an electrically conductive part to the first material and coupling a nonelectrically conductive part to the structure and to the electrically conductive part.

### CROSS-REFERENCE TO RELATED APPLICATIONS

This application claims priority to U.S. Provisional Application No. 63/749,429 entitled “ELECTROPOLISHING PROCESS FOR INTERNAL SURFACES OF AM PARTS” and filed on Jan. 24, 2025, wherein the provisional application is expressly incorporated by reference herein in its entirety.

### BACKGROUND

### Field

The disclosure relates generally to a finishing process, and more specifically to electropolishing and electroplating surfaces of simple and complex structures such as internal surfaces of additive manufactured (AM) structures.

### Background

Three-dimensional (3-D) printing, also referred to as additive manufacturing (AM), has recently presented new opportunities to more efficiently build complex transport structures, such as structures and joined/assembled structures forming automobiles, aircraft, boats, motorcycles, buses, trains, gearboxes, semiconductors, and the like. AM techniques are capable of fabricating complex structures from various materials. Applying AM processes to industries that produce these structures has proven to produce a structurally more efficient transport structure. For example, an aircraft or automobile produced using 3-D printed structures may be made stronger, lighter, and consequently, more fuel efficient. Moreover, AM enables manufacturers to 3-D print structures that are more complex in shape and form and that are equipped with more advanced features and capabilities than structures made using traditional machining and casting techniques. For example, a 3-D printed structure may include complex internal volumes, passageways and channels and varying dimensional sections. The 3-D printed structures may be formed using layers of material based on a digital model data of the structure. A 3-D printer may form the structure defined by the digital model data by printing the structure one layer at a time.

3-D printing provides geometric and design flexibility that conventional manufacturing processes may not be able to obtain. Furthermore, 3-D printing technologies can produce structures with very small feature sizes, and geometries that are either significantly difficult or impossible to produce using conventional manufacturing processes.

Manufacturers typically rely on different mass finishing techniques to achieve surface finishes on structures with a simple shape or on external surfaces of structures. Due to the complex internal shapes and passages of some structures including AM structures, there exists a need to finish the internal surfaces within these complex internally shaped and passage structures, which may form transport structures and other vehicle assemblies. Thus, this disclosure provides high quality surface finishes on internal surfaces within complex internally shaped and passage structures as well as on external surfaces of complex shaped structures. This disclosure also may be applied to provide high quality surface finishes of simple shaped structures and on the external surfaces of these structures. Thus, this disclosure may be applied or used on any surface of any structure to achieve a high quality surface finish.

### SUMMARY

Several aspects of apparatuses, systems and methods for finishing surfaces of structures such as internal and external surfaces of simple and complex AM structures will be described more fully hereinafter. Additionally, three-dimensional printing techniques of these structures will be described.

In one or more embodiments disclosed herein is a method including placing a first material within an internal volume of a structure, shrinking the first material such that a gap is formed between the first material and a surface of the structure, and applying a voltage across the gap.

In one or more embodiments, shrinking the first material may include curing the first material and/or applying thermal energy to the first material.

In one or more embodiments, applying the voltage may include an electropolishing process or an electroplating process.

In one or more embodiments, the first material may include an adhesive. The adhesive may include an electrically conductive adhesive. The adhesive may include one or more electrically conductive elements/components.

In one or more embodiments, the method optionally may include applying a second material to the surface of the structure such that the second material contacts the first material. The second material may include a release agent.

In one or more embodiments, the method may include the first material separates from the release agent and/or the surface of the structure when shrinking of the first material.

In one or more embodiments, the method may further include controlling the gap between the first material and the surface of the structure.

In one or more embodiments, controlling the gap may include coupling an electrically conductive part to the first material. The electrically conductive part may include one or more wires.

In one or more embodiments, controlling the gap may include coupling a nonelectrically conductive part to the structure and to an electrically conductive part.

In one or more embodiments, coupling the electrically conductive part to the first material may include inserting the electrically conductive part into the first material such that the electrically conductive part lies within more than half of a length of the first material.

In one or more embodiments, coupling the electrically conductive part to the first material may include coupling a first wire of the one or more wires to a first end of the first material and coupling a second wire of the one or more wires to a second end of the first material.

In one or more embodiments, placing the first material within the internal volume of the structure may include contacting the first material with the surface of the structure.

In one or more embodiments, the first material may separate from the surface of the structure when shrinking of the first material.

It will be understood that other aspects of structures, joining of structures and subcomponents, and methods and systems of finishing surfaces will become readily apparent to those skilled in the art from the following detailed description, wherein it is shown and described only several embodiments by way of illustration. As will be realized by those skilled in the art, the apparatuses, methods and systems for finishing surfaces are capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of apparatuses, systems and methods for electropolishing and electroplating surfaces of structures such as internal and external surfaces of simple and complex AM structures will now be presented in the detailed description by way of example, and not by way of limitation, in the accompanying drawings, wherein:

FIGS. 1A-1D illustrate respective side views of a 3-D printer system in accordance with an aspect of the present disclosure.

FIG. 1E illustrates a functional block diagram of a 3-D printer system in accordance with an aspect of the present disclosure.

FIGS. 2A-2D illustrate cross-sectional views of and FIG. 2E illustrates a perspective view of an embodiment of an apparatus, system and process of performing a finishing process on a surface of structures in accordance with an aspect of the present disclosure.

FIGS. 3A-3E illustrate cross-sectional views of and FIG. 3F illustrates a perspective view of an embodiment of an apparatus, system and process of performing a finishing process on a surface of structures in accordance with an aspect of the present disclosure.

FIG. 4 is a flowchart illustrating an example method in accordance with the apparatuses, systems and methods described herein.

### DETAILED DESCRIPTION

The detailed description set forth below in connection with the drawings is intended to provide a description of example embodiments finishing internal and/or external surfaces of structures such as simple and/or complex shaped internal volumes and passages of structures as well as external surfaces of these structures. The structures may include AM structures or other manufactured structures. The structures may be structures that are to be joining together or the structures may be joined structures that form part of or form automobiles, aircraft, boats, motorcycles, buses, trains, gearboxes, semiconductors, and the like. The structures and methods are not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

### Additive Manufacturing

Additive Manufacturing (AM) involves the use of a stored geometrical model for accumulating layered materials on a build plate to produce a three-dimensional (3-D) build piece having features defined by the model. AM techniques are capable of printing simple and complex structures using a wide variety of materials. A 3-D structure may be fabricated based on a computer aided design (CAD) model. The CAD model can be used to generate a set of instructions or commands that are compatible with a particular 3-D printer. The AM process can create/manufacture a three-dimensional structure using the CAD model and print instructions. In the AM process, different materials or combinations of material, such as engineered plastics, thermoplastic elastomers, metals, ceramics, and/or alloys or combinations of the above, etc., may be used to create a three-dimensional structure.

The use of producing AM structures may provide significant flexibility and cost saving benefits. These, and other benefits may enable manufacturers of mechanical structures to produce the structures at a lower cost and/or in a more efficient manner. The techniques described in the present disclosure relate to a process for finishing structures such as AM structures, and/or other manufactured structures, and/or commercial off the shelf (COTS) structures. AM structures are 3-D structures that are printed by, for example, adding layer upon layer of one or more materials based on a preprogramed design. For example, the structure may be formed by a powder bed fusion (PBF) system/printer. The structures described herein may be structures used to assemble a variety of devices, such as engine components, structural components, etc. Further, such AM or COTS structures may be used in assemblies, such as vehicles, trucks, trains, motorcycles, boats, aircraft, and the like, or other mechanized assemblies, without departing from the scope of the present disclosure. Assembly of these structures may be performed robotically (e.g., by robots) or manually or a combinator of manual and robotic assembly.

### Structures and Terminology in AM

In an aspect of the present disclosure, a structure may be an example of an AM structure or a structure manufactured by other manufacturing methods. The structure may include structures joined together that form part of or form automobiles, aircraft, boats, motorcycles, buses, trains, gearboxes, semiconductors, and the like. A structure may be any 3-D printed structure that includes features, such as an interface, for mating with another component. The structure may have internal or external features configured to accept a particular type of structure. Alternatively or additionally, the structure may be shaped to accept a particular type of structure. A structure may utilize any internal design or shape and accept any variety of structures without departing from the scope of the disclosure.

A structure interface may be configured to connect to an interface of another structure. For example, and not by way of limitation, an interface between structures may be a tongue-and-groove structure. The interface may have high precision features or complex geometries that allow them to perform specific functions, including creating connections to spanning structures such as tubes, structural panels, extrusions, sheet metal, and/or other structural members.

For clarity, structures may also include relatively simple connection features configured to connect with the more sophisticated network of connection features of the interface to form streamlined connections between structures. While these structures may incorporate more basic features, they advantageously may be 3-D printed at a higher print rate. Alternatively, structures may be built/manufactured using any 3-D print manufacturing or other manufacturing technology.

A number of different AM technologies may be well-suited for construction of structures in a transport structure or other mechanized assembly. Such 3-D printing techniques may include, for example, directed energy deposition (DED), selective laser melting (SLM), selective laser sintering (SLS), direct metal laser sintering (DMLS), electron beam melting (EBM), powder bed fusion (PBF), and/or other AM processes involving melting or fusion of metallic powders.

As in many 3-D printing techniques, these processes (e.g., PBF systems) can create build pieces (e.g., structures) layer-by-layer. Each layer or “slice” is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up. SLS and various other PBF techniques may be well suited to construction of gear cases and other transport structure components. However, it will be appreciated that other AM techniques, such as fused deposition modeling (FDM) and the like, are also possible for use in such applications.

While the disclosure relates primarily to finishing of complex internal volumes, channels and passageways of AM structures, the techniques described in his disclosure are not only applicable to internal volumes, channels and passageways. For instance, the techniques may be applied to external surfaces of structures as well. In addition, while the disclosure also describes finishing surfaces of AM structures using electropolishing and electroplating, any suitable technique for polishing a surface may be used without departing from the scope of the disclosure.

AM may include the manufacture of one or more structures. Using AM, a structure may be constructed to include additional features and functions, including interface functions, depending on the objectives.

A focus of the AM industry has been around printing geometries with good surface quality. However, it may be difficult to alter printing parameters to achieve geometries with good surface quality without having to print supports. Printing supports is non-ideal because the supports are difficult to remove and leave residual material on the surface which may be problematic for certain applications.

There are several mass finishing techniques that may be applied to achieve a high quality finish on simple objects or external surfaces. For example, a first mass finishing technique is electrochemical machining, which is a method of removing metal by an electrical chemical process. Electrochemical machining may be used for mass production and for working extremely hard materials or materials that are difficult to machine using conventional methods. In the electrochemical process, a negatively-charged (e.g., cathode) cutting tool is advanced into a positively charged (e.g., anode) workpiece such that a charge exchange takes place between the cathode and the anode in an aqueous electrolyte solution which targets specific areas of the workpiece. This can be used to create contours, ring ducts, grooves or bell hollows with no contact. The removed material may be precipitated from the electrolyte solution in the form of metal hydroxide. However, electrochemical machining requires specific tooling, which defeats the benefit of AM since AM may manufacture infinitely different geometry structures and creating a specific tool for each varied structure is cost prohibited.

Another mass finishing technique is abrasive flow machining, which flows an abrasive-laden fluid or a semi-solid abrasive-laden putty through or across parts to grind (e.g., finish) or remove a small quantity of material from a surface to be finished at very high temperatures. Abrasive flow machining may be useful when applied to workpieces containing passageways that are considered to be inaccessible with conventional deburring and polishing tools. However, equipment for abrasive flow machining is very expensive and features must be designed to adapt to the equipment. In addition, in abrasive flow machining techniques, each passageway has to be addressed independently, which may not be practical for structures with complex geometries.

Although these mass finishing techniques may be applied to objects with simple internal surfaces (e.g., one passage in a consistent size), these mass finishing techniques may not be viable for parts with multiple passages containing different sizes, different orientations and different trajectories.

Accordingly, it would be useful to implement a general solution to the above mentioned issues by effectively and inexpensively polishing/plating/treating difficult to access inner surfaces of a structure. In addition, having a robust solution to clean up complex geometries of AM structures would allow mass printing of these structures with very difficult to finish geometries economically. Furthermore, the solution may also be used to clean up internal surfaces, which include multiple and complex passages and volumes.

The present disclosure is directed to finishing surfaces (e.g., internal and external surfaces) of simple and complex structures such as AM structures that may be assembled by robots to form a transport structure such as automobiles, aircraft, boats, motorcycles, buses, trains, gearboxes, semiconductors, and the like. Specifically, the present disclosure describes a process of finishing complex internal volumes, channels and passageways of AM structures using electropolishing and electroplating. A first material is placed within an internal volume of a structure. The first material shrinks such that a gap is formed between the first material and a surface of the structure. A voltage is applied across the gap in order to electropolish or electroplate the internal surface of the structure. Optionally, a second material may be applied to the surface of the structure such that the second material contacts the first material and the first material separates from internal surface of the structure and/or the second material forming the gap when the first material shrinks. Applying the voltage across the gap may be repeated multiple times until a desired finish is produced for all desired surfaces of the structure.

### Additive Manufacturing Environment

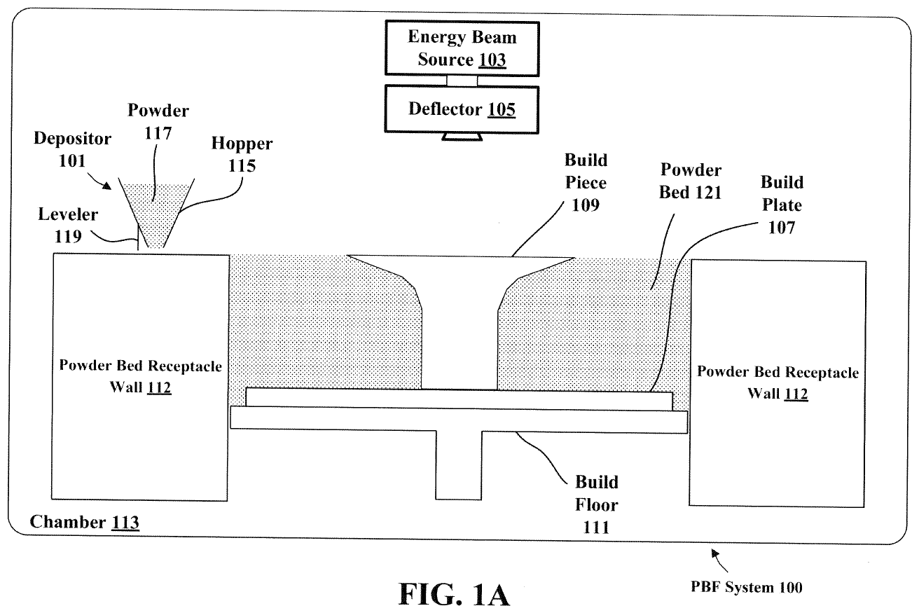

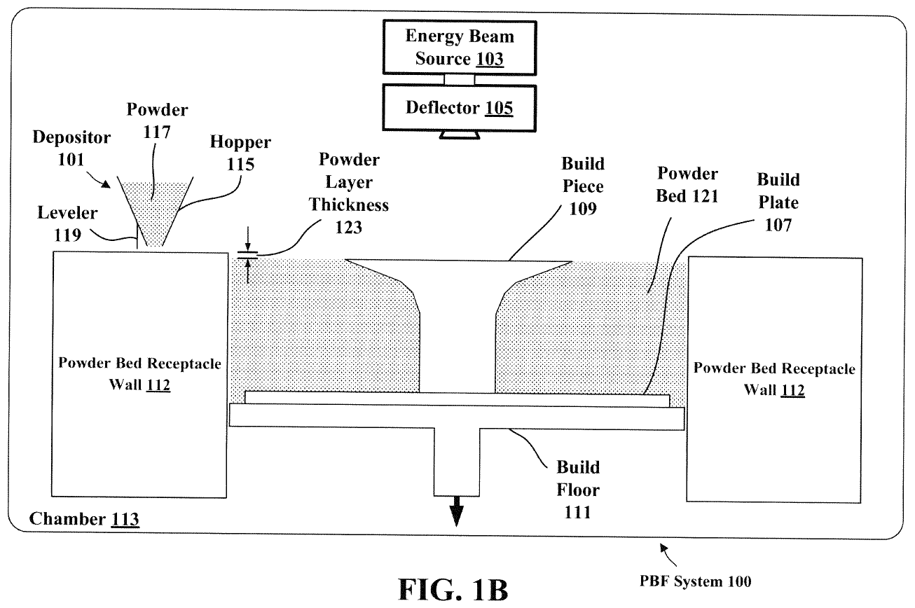

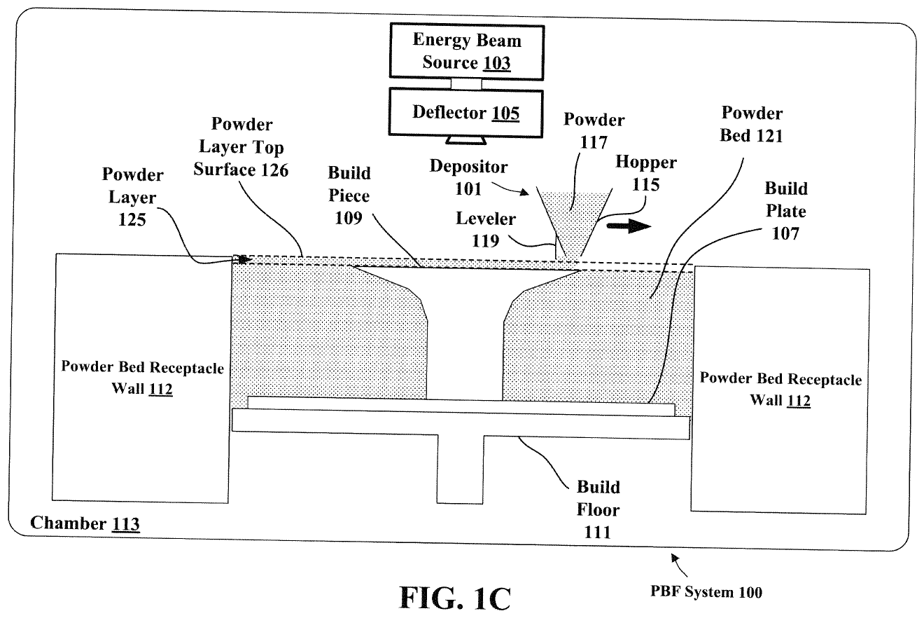

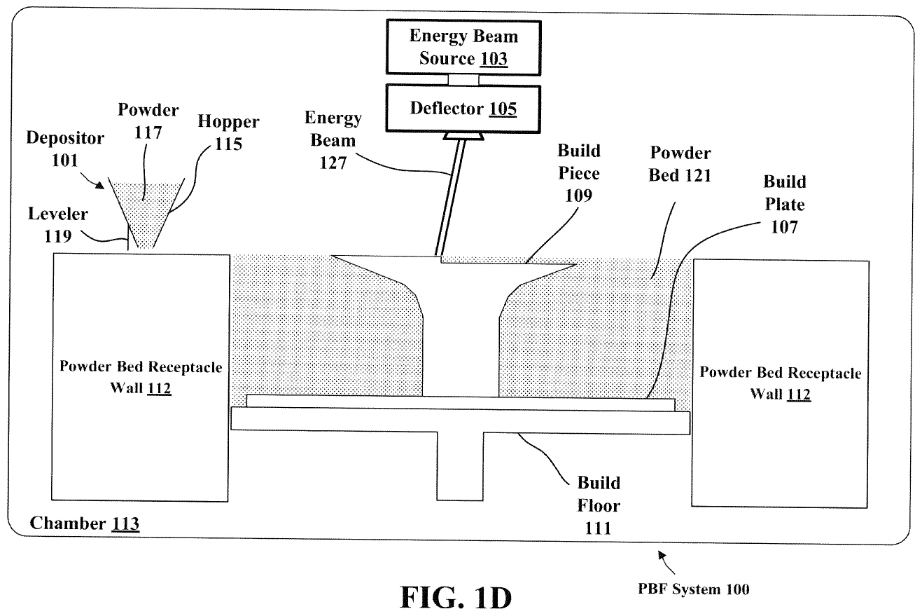

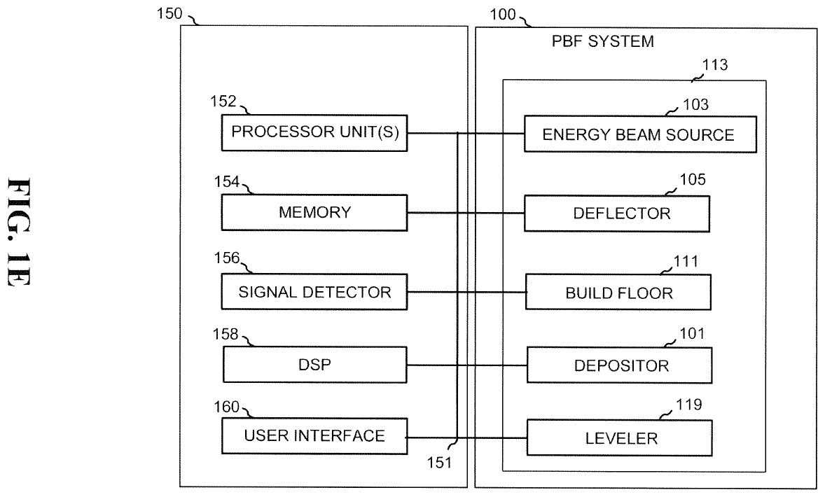

FIGS. 1A-1D illustrate respective side views of a 3-D printer system (e.g., a PBF system) in an aspect of the present disclosure.

In an aspect of the present disclosure, a 3-D printer system may be a powder-bed fusion (PBF) system 100. FIGS. 1A-D show PBF system 100 during different stages of operation. The particular embodiment illustrated in FIGS. 1A-1D is one of many suitable examples of a PBF system employing principles (e.g. creating and manufacturing one or more structures) of this disclosure. It should also be noted that elements of FIGS. 1A-1D and the other figures in this disclosure are not necessarily drawn to scale, but may be drawn larger or smaller for the purpose of better illustration of concepts described herein. PBF system 100 may include a depositor 101 that can deposit each layer 125 of powder 117 (e.g., metal powder), an energy beam source 103 that can generate an energy beam 127, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 may also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 may include a hopper 115 that contains a powder 117, such as a metal powder, and a leveler 119 that can level the top of each layer of deposited powder.

Referring specifically to FIG. 1A, FIG. 1A illustrates PBF system 100 after a slice of build piece 109 has been fused, but before the next layer of powder has been deposited. In fact, FIG. 1A illustrates a time at which PBF system 100 has already deposited and fused slices in multiple layers, e.g., 200 individual layers, to form the current state of build piece 109, e.g., formed of 200 individual slices. The multiple individual layers already deposited have created a powder bed 121, which includes powder that was deposited but not fused.

FIG. 1B illustrates PBF system 100 at a stage in which build floor 111 can lower by a powder layer thickness 123. The lowering of build floor 111 causes build piece 109 and powder bed 121 to drop by powder layer thickness 123, so that the top of build piece 109 and powder bed 121 are lower than the top of powder bed receptacle wall 112 by an amount equal to the powder layer thickness 123. In this way, for example, a space with a consistent thickness equal to powder layer thickness 123 can be created over the tops of build piece 109 and powder bed 121.

FIG. 1C illustrates PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that leaves powder layer top surface 126 configured to receive fusing energy from energy beam source 103. Powder layer 125 has a thickness substantially equal to the powder layer thickness 123 (see FIG. 1). Thus, the powder in a PBF system can be supported by a powder material support structure, which may include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving the 200 previously-deposited individual layers discussed above with reference to FIG. 1A.

FIG. 1D illustrates PBF system 100 at a stage in which, following the deposition of powder layer 125 (FIG. 1C), energy beam source 103 generates an energy beam 127 and deflector 105 applies the energy beam to fuse the next slice in build piece 109. In various embodiments, energy beam source 103 may be an electron beam source, in which case energy beam 127 constitutes an electron beam. Deflector 105 may include deflection plates that can generate an electric field or a magnetic field that selectively deflects the electron beam to cause the electron beam to scan across areas designated to be fused. In various embodiments, energy beam source 103 may be a laser, in which case energy beam 127 is a laser beam. Deflector 105 may include an optical system that uses reflection and/or refraction to manipulate the laser beam to scan selected areas to be fused.

In various embodiments, the deflector 105 may include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam may be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a control device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may include one or more processor units 152, memory 154, a signal detector 156, a digital signal processor (DSP) 158, and one or more user interfaces 160. Computer 150 may include additional components without departing from the scope of the present disclosure.

The computer 150 may include one or more processor units 152, which may assist in the control and/or operation of PBF system 100. The processor unit 152 may also be referred to as a central processing unit (CPU). Memory 154, which may include both read-only memory (ROM) and random access memory (RAM), may provide instructions and/or data to the processor. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, deflector 105 position, build floor 111 height, amount of powder 117 remaining in depositor 101, leveler 119 position, and other signals. Signal detector 156, in addition to or instead of processor unit 152 may also control other components as described with respect to the present disclosure. The computer 150 may also include a DSP 158 for use in processing signals received by the computer 150. The DSP 158 may be configured to generate instructions and/or packets of instructions for transmission to PBF system 100.

The computer 150 may further comprise a user interface 160 in some aspects. The user interface 160 may include a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software as described above.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium includes a non-transitory computer readable medium (e.g., tangible media).

### Apparatus, System and Finishing Process

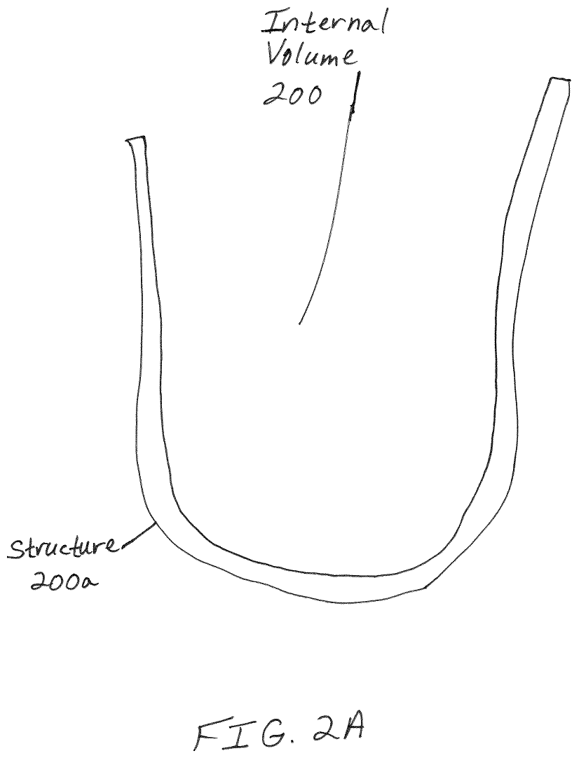

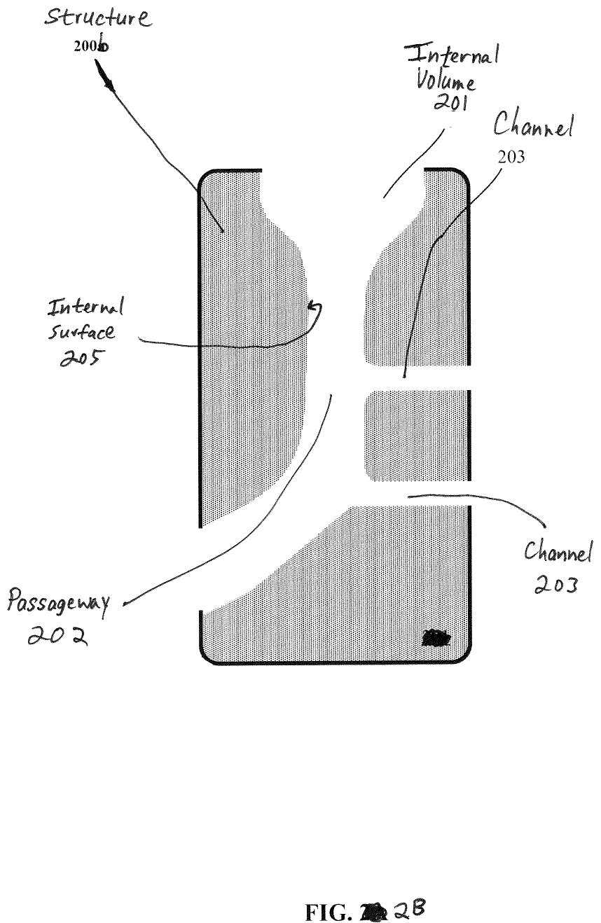

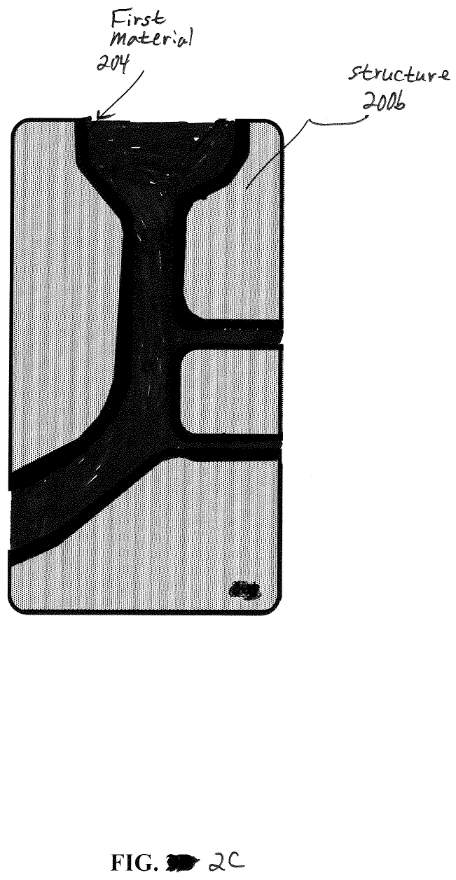

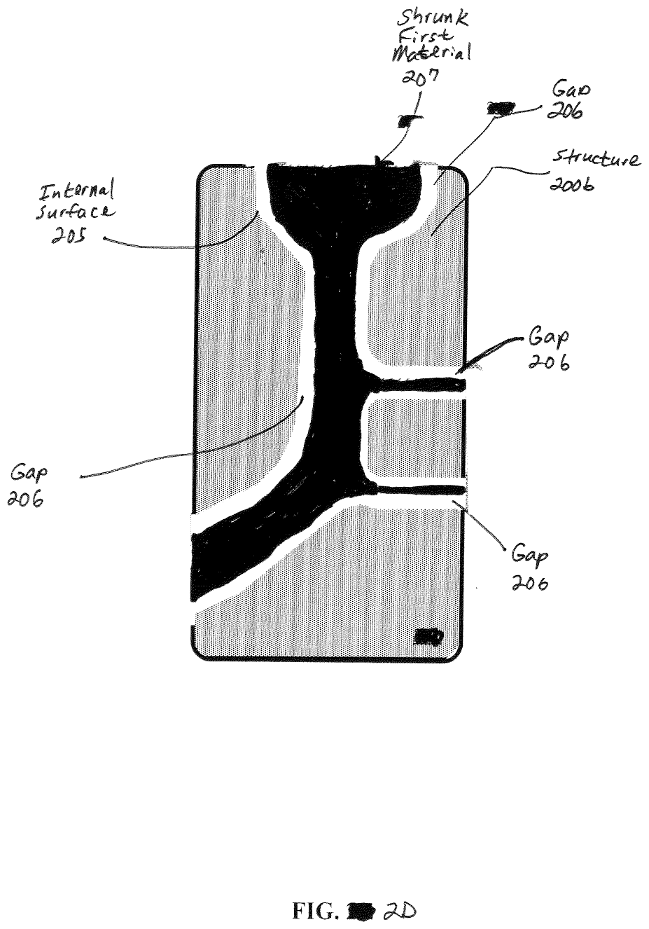

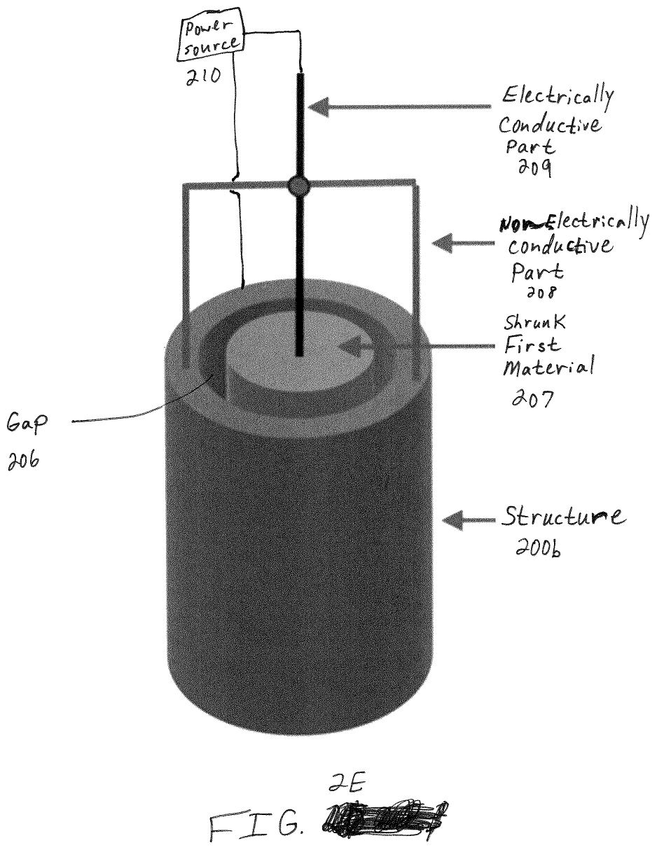

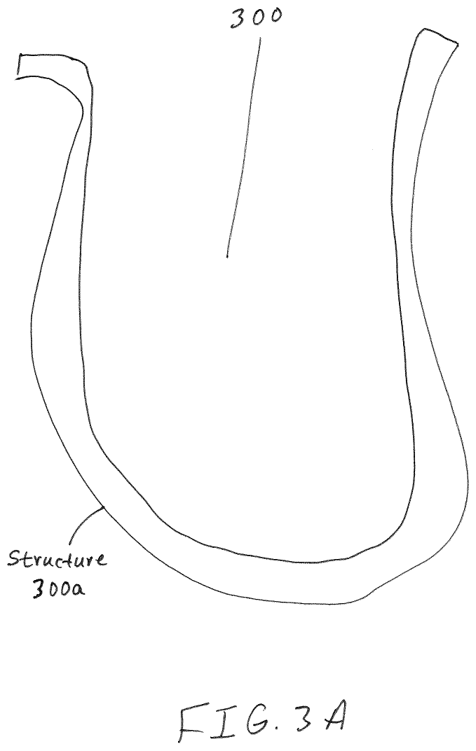

FIGS. 2A-2E illustrate an apparatus, system and process for performing a finishing process of internal and external surfaces of a structure. For example, in one or more embodiments performing a finishing process on internal surfaces of volumes, channels and passageways of structures such as AM structures will be described in detail in accordance with an aspect of the present disclosure.

FIG. 2A illustrates an example of a structure 200a that may have its internal surfaces and/or external surfaces electropolished or electroplated. Structure 200a includes an internal volume 200. The internal volume may include any geometric shape including simple and complex shapes. For example, the internal volume may have different sizes, shapes and orientations, and/or trajectories from what is illustrated in the example structure shown in FIG. 2A and may make the internal volume difficult to clean. Optionally, the structure may include one or more internal volumes, and/or one or more passageways and/or one or more channels. For example, the structure may include one or more internal volumes and each internal volume may include one or more passageways. Additionally or alternatively, the structure may include one or more channels.

FIG. 2B illustrates an example of a structure 200b that may have its internal surfaces and/or external surfaces electropolished or electroplated. Structure 200b includes an internal volume 201, a passageway 202 and internal channels 203. The internal volume may include the passageway. The internal volume, passageway and channels may be configured to provide for an electropolishing process or an electroplating process as will be shown and described below. Moreover, the internal volume, passageway and channels may include any geometric shape including simple and complex shapes. For example, the internal volume, the passageway and the channels may have different sizes, shapes and orientations, and/or trajectories from what is illustrated in the example structure shown in FIG. 2B and may make the internal volume, passageway and channels difficult to access, especially for electropolishing and/or electroplating. The structure may include a plurality of internal volumes and each internal volume may include one or more passageways. Also, the structure may include more or less channels than illustrated in FIG. 2B.

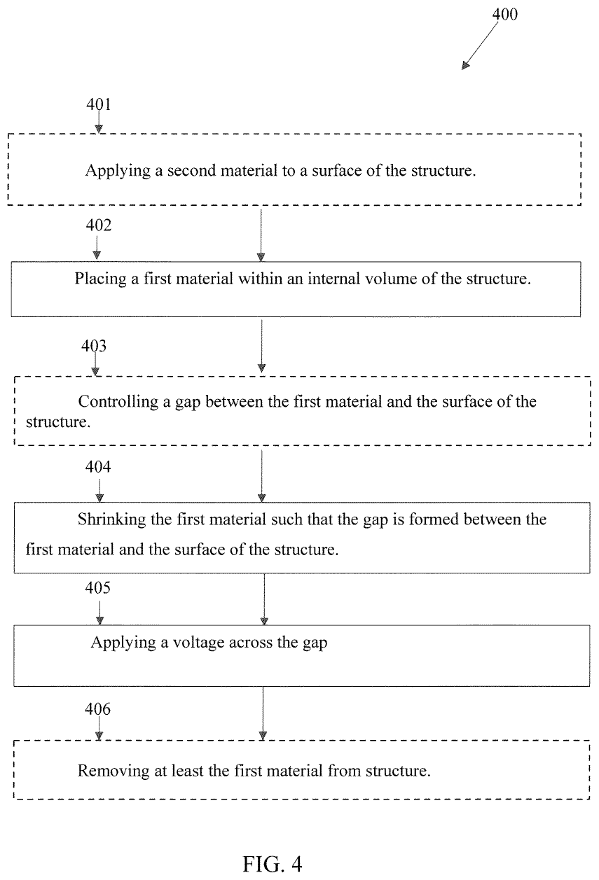

In one or more embodiments, a first material can be placed within the internal volume of a structure, such as described the process illustrated in FIG. 4. FIG. 2C illustrates example structure 200b having a first material 204 placed within internal volume 201. Structure 200b includes first material 204 contacting an internal surface 205 of the structure. The first material may be manually or robotically or a combination thereof placed within the internal volume. In one or more embodiments, first material 204 may be a liquid, and placing the first material within internal volume 201 may include pouring the first material into the internal volume. The first material may be placed within the internal volume, including the passageways, internal channels, etc., of the structure. The first material may contact the entire internal surface of the structure as illustrated in FIG. 2C. For example, when placing the first material within the structure, the first material may be in the form/state such that the first material may flow to contact the entire internal surface of the structure as illustrated in FIG. 2C. In one or more embodiments, the first material may be in the form of a liquid and placed within the internal volume and the first material may fully contact the internal surface of the structure. In one or more embodiments, the first material may contact only one or more sections/portions of the internal surface of the structure. In one or more embodiments, due to the placing of the first material within the structure and/or the form/state of the first material and/or the shape of internal surface, the first material may contact only one or more sections/portions of the internal surface of the structure. For example, the first material may be placed within the internal volume and the first material may be in the form of a liquid and due to the shape of the surface of the internal volume, the first material only contacts the internal volume portion of the internal surface of the structure.

In one or more embodiments, the first material can be shrunk such that a gap is formed between the first material and a surface of the structure, such as described the process illustrated in FIG. 4. FIG. 2D illustrates example structure 200b showing the first material having been shrunk by the below disclosed methods, forming a gap between the inner surface of the structure and the shrunk first material. For example, structure 200b includes gaps 206 between the shrunk first material 207 and the internal surface 205 of the structure. Therefore, the first material 204 on the inner surface 205 as shown in FIG. 2C is illustrated as the shrunk first material 207 in FIG. 2D. The first material shrinks when cured and/or thermally exposed and when the first material shrinks (i.e. cured and/or thermally exposed) the shrunk first material separates from the inner surface of the structure forming the gaps illustrated in FIG. 2D. Thus, FIG. 2D illustrates the first material having been shrunk and separated from the inner surface of the structure and forming/creating gaps 206 between the first material and the internal surface of the structure enabling electropolishing or electroplating of the structure's internal surface. As disclosed above, because the structure in FIG. 2D is an example structure, the structure may include an internal volume or the structure may include one or more internal volumes and/or one or more passageways and/or one or more on channels. Thus, there may be more or less gaps than illustrated in FIG. 2D. The first material may include a polymer or a monomer or oligomer such that when the first material undergoes polymerization or is cured or is exposed to thermal energy forms an adhesive and shrinks in volume. For example, methyl methacrylate may have a shrinkage of 25% by volume during a curing process and shrinkage of Nylon12 may be about 4.7% by volume during a curing process. Also, UV cured monomers, such as trimethyloyl propane triacrylate, shrink almost 29% by volume during the curing process.

In one or more embodiments, a voltage can be applied across the gap, such as described the process illustrated in FIG. 4. FIG. 2E illustrates more, details of the apparatus, system and process for electropolishing or electroplating the surface of the structure. Structure 200b includes an electrically conductive part 209 coupled to the shrunk first material 207, a nonelectrically conductive part 208 coupled to the electrically conductive part and the structure, and a power source 210 coupled to the electrically conductive part and the structure. Structure 200b further illustrates gap 206 between the shrunk first material and the internal surface of the structure. The power source provides a potential difference between the electrically conductive part and the structure such that a voltage is applied across the gap. For example, to electropolish the internal surface of the structure, the power source creates a potential difference between the electrically conductive part and the structure such that the electrically conductive part is functioning as a cathode and the structure is functioning as an anode, thus applying a voltage across the gap. If the internal surface of the structure is to be electroplated, then the power source creates a potential difference between the electrically conductive part and the structure such that the electrically conductive part is functioning as an anode and the structure is functioning as an cathode, thus applying a voltage across the gap. During an electropolishing process and an electroplating process, a processing media such as a fluid (e.g., a liquid, which may include a mixture of fluids) may be within the gap. The electrically conductive part and/or the nonelectrically conductive part may also perform the function of controlling the gap between the first material and the surface of the structure. For example, the electrically conductive part coupled to the shrunk first material enables the shrunk first material to be moved away, preventing from contacting and maintaining a distance away from the surface of the structure. The nonelectrically conductive part may also control the gap between the first material and the surface of the structure by positioning the nonelectrically conductive part on or within the structure such that the shrunk first material is positioned to a desired distance away from the surface of the structure, preventing the shrunk first material from contacting the surface of the structure and maintaining a distance away from the surface of the structure due to the nonelectrically conductive part being also coupled to the electrically conductive part, which is coupled to the shrunk first material. The electrically conductive part may be coupled to the center or centroid of the shrunk first material to provide a uniform electrical field through the gap and when performing the electropolishing or electroplating process. In one or more embodiments, the electrically conductive part may include one or more wires. The one or more wires include a metal or an alloy or other known or equivalent electrically conductive material. In one or more embodiments, the electrically conductive part may be a wire inserted into the shrunk first material or inserted into the first material before the first material is shrunk. In one or more embodiments, the electrically conductive part may include two wires, where one wire in coupled to a first end of the first material or the shrunk first material and a second wire is coupled to a second end of the first material or the shrunk first material. The nonelectrically conductive part may include rubber, ceramics, plastics, wood, fiberglass or other known or equivalent nonelectrically conductive material. The nonelectrically conductive part may include a plurality of connected elements or a single element. For example, the nonelectrically conductive part may include a plurality of plastic elements connected together and ends of two of the plastic elements may be fastened to the structure with an adhesive or screws or rivets or a combination thereof or other known fastening devices and ends of one or two other plastic elements may be fastened to the electrically conductive part with an adhesive or screws or rivets or a combination thereof or other known fastening devices.

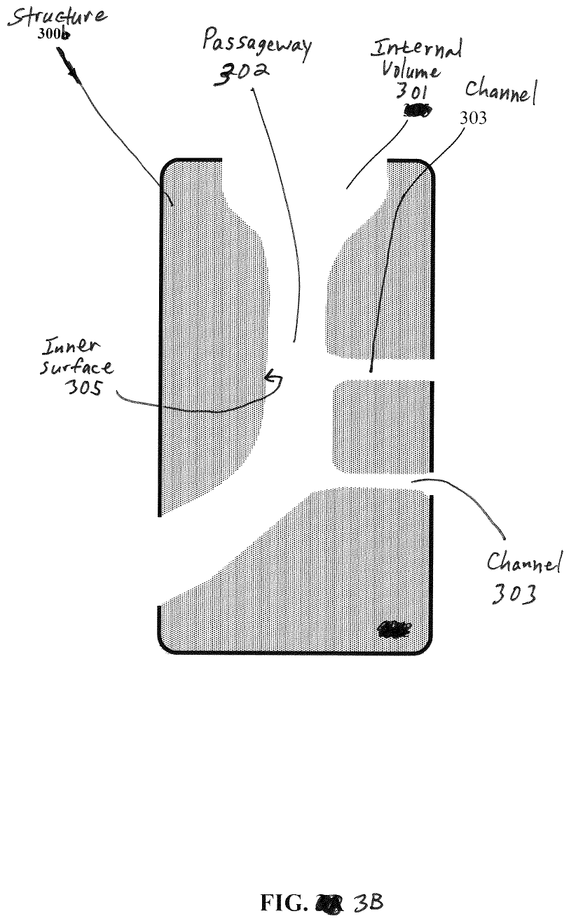

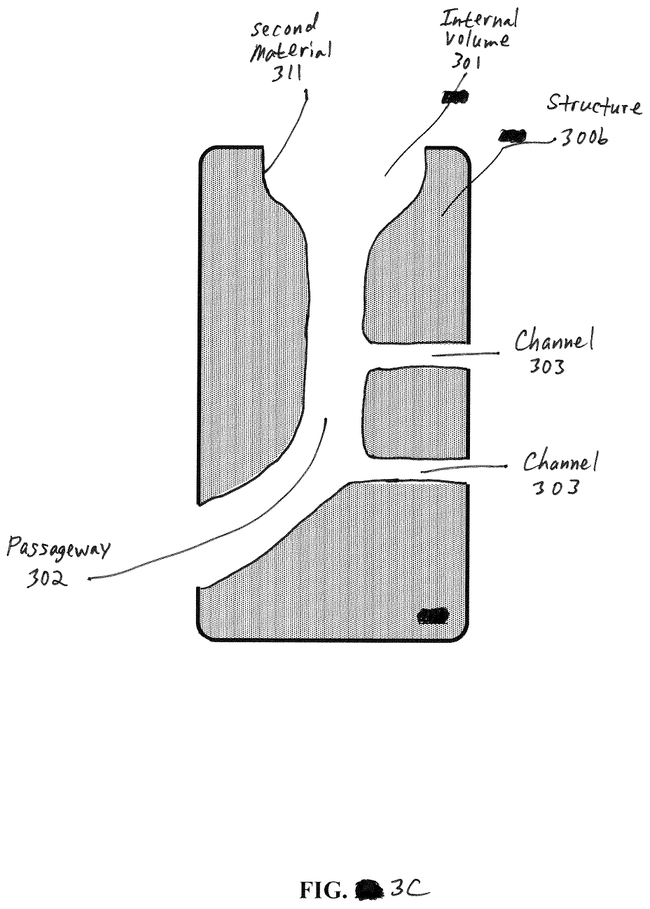

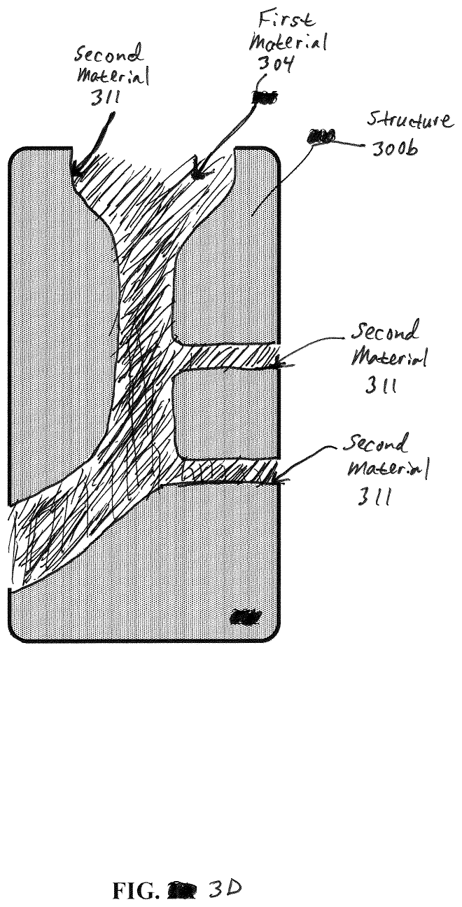

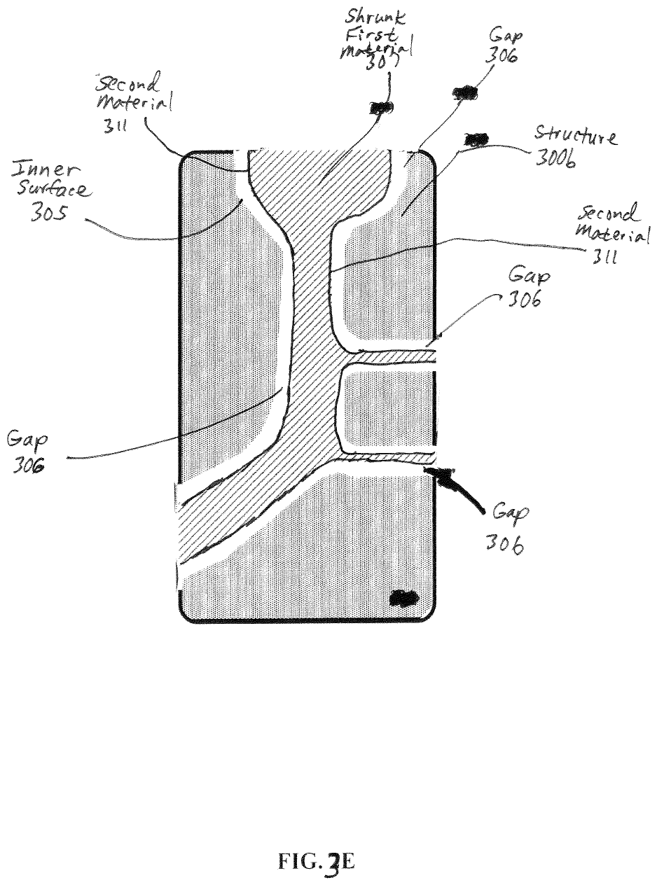

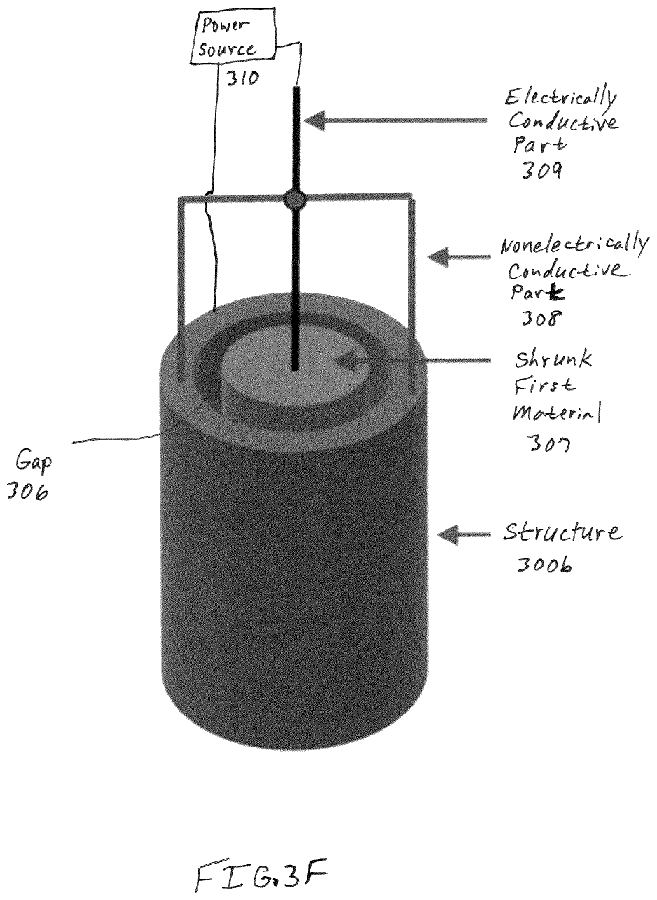

FIGS. 3A-3F illustrate an apparatus, system and process for performing a finishing process of internal and external surfaces of a structure. For example, FIGS. 3A-3F illustrate one or more embodiments of performing a finishing process on internal surfaces of volumes, channels and passageways of structures such as AM structures.

FIG. 3A illustrates an example of a structure 300a that may have its internal surfaces and/or external surfaces electropolished or electroplated. Structure 300a includes an internal volume 300. The internal volume may include any geometric shape including simple and complex shapes. For example, the internal volume may have different sizes, shapes and orientations, and/or trajectories from what is illustrated in the example structure shown in FIG. 3A and may make the internal volume difficult to clean. Optionally, the structure may include one or more internal volumes, and/or one or more passageways and/or one or more channels. For example, the structure may include one or more internal volumes and each internal volume may include one or more passageways. Additionally or alternatively, the structure may include one or more channels.

FIG. 3B illustrates an example of a structure 300b that may have its internal surfaces and/or external surfaces electropolished or electroplated. Structure 300b includes an internal volume 301, a passageway 302 and internal channels 303. The internal volume may include the passageway. The internal volume, passageway and channels may be configured to provide for an electropolishing process or an electroplating process as will be shown and described below. Moreover, the internal volume, passageway and channels may include any geometric shape including simple and complex shapes. For example, the internal volume, the passageway and the channels may have different sizes, shapes and orientations, and/or trajectories from what is illustrated in the example structure shown in FIG. 3B and may make the internal volume, passageway and channels difficult to clean. The structure may include a plurality of internal volumes and each internal volume may include one or more passageways. Also, the structure may include more or less channels than illustrated in FIG. 3B.

In one or more embodiments, a second material may be applied to the surface of the structure such that the second material contacts the first material, such as described the process illustrated in FIG. 4. FIG. 3C illustrates example structure 300b having its internal surface coated with a second material. Structure 300b includes a second material 311 on an internal surface 305 of the structure. The second material may be manually or robotically or a combination thereof placed within the internal volume. However, the second material may be placed within the internal volume and/or the passageway and/or one or more of the internal channels of the structure. The second material may fully coat the internal surface of the structure as illustrated in FIG. 3C. The second material (e.g. a release agent) may be a material that poorly adheres to the surface of the structure. The second material (e.g. a release agent) may be a material that does not bond to the surface of the structure. In one or more embodiments, when placing the second material within the structure, the second material may be in the form/state such that the second material may fully coat the internal surface of the structure as illustrated in FIG. 3C. For example, the second material may be in the form of a liquid and placed within the internal volume and thus, the second material may fully coat the internal surface of the structure. In one or more embodiments, coating the second material on the inner surface may include immersing the structure in a solvent containing the second material, draining excess liquid from the structure, and removing (e.g., by evaporating) residual solvent such that the second material coats the inner surface of the structure. The second material may include a release agent, where the release agent is configured to ensure proper release from the first material (e.g. an adhesive) and/or from the structures' surface as will be described below. In one or more embodiments, the second material may bond to the first material and when the first material shrinks (as shown and disclosed below in FIG. 3E), the second material separates from the inner surface of the structure and the shrunk first material contains the separated second material. In one or more embodiments, second material may bond to the inner surface, and when the first material shrinks (as shown and disclosed below in FIG. 3E), the first material separates from the second material, and second material may stay attached to the inner surface while the first material pulls away. In one or more embodiments, the second material may coat only one or more sections/portions of the internal surface of the structure. For example, the second material may be placed within the internal volume and/or the passageway and/or one or more of the internal channels of the structure. And due to the placing of the second material within the structure and/or the form/state of the second material and/or the shape of internal surface, the second material may coat only one or more sections/portions of the internal surface of the structure. For example, the second material may be placed within the internal volume and the second material may be in the form of a liquid and due to the shape of the surface of the internal volume, the second material only coats the internal volume portion of the internal surface of the structure. In one or more embodiments in which the second material is a liquid, for example, the structure may be dipped in the second material, such that the second material contacts the inner surface, and removed to allow the second material to coat and dry on the inner surface.

In one or more embodiments, a first material can be placed within the internal volume of a structure, such as described the process illustrated in FIG. 4. FIG. 3D illustrates example structure 300b showing a first material 304 placed within the structure after the second material 311 has coated the inner surface of the structure. For example, once the second material has been placed within the structure or coated on the surface of the structure, the first material may be manually or robotically or a combination thereof placed within the internal volume and/or the passageway and/or one or more of the internal channels of the structure such that the first material contacts the second material. When placing the first material within the structure, the first material may be in the form/state such that the first material may fully contact the second material as illustrated in FIG. 3D. For example, the first material may be in the form of a liquid and placed within the internal volume and thus, the first material may fully contact the second material. However, the first material may contact only one or more sections/portions of the second material and/or one or more sections/portions of the internal surface, if the second material does not fully contact the entire inner surface of the structure. In one or more embodiments, due to the placing of the first material within the structure and/or the form/state of the first material and/or the shape of internal surface, the first material may contact only one or more sections/portions of the second material and/or one or more sections/portions of the internal surface of the structure. For example, the first material may be placed within the internal volume and the first material may be in the form of a liquid and due to the shape of the surface of the internal volume, the first material only contact the second material within the internal volume and/or internal volume portion of the internal surface of the structure.

In one or more embodiments, the first material can be shrunk such that a gap is formed between the first material and a surface of the structure, such as described the process illustrated in FIG. 4. FIG. 3E illustrates example structure 300b showing the first material having been shrunk by the below disclosed methods. For example, structure 300b includes gaps 306 between the shrunk first material 307 and the internal surface 305 of the structure. Therefore, the first material 304 as shown in FIG. 3D is illustrated as the shrunk first material 307 in FIG. 3E. Thus, FIG. 3E illustrates the first material having been shrunk and moved away from the inner surface of the structure and thus formed/created gaps 306 between the first material and the internal surface of the structure enabling electropolishing or electroplating of the structures' internal surface. The first material shrinks when cured and/or thermally exposed and when the first material shrinks (i.e. cured and/or thermally exposed) the shrunk first material moves away from the inner surface of the structure and forms the gaps illustrated in FIG. 3E. In one or more embodiments, the second material may bond to the first material and when the first material shrinks and moves away from the inner surface of the structure, the second material separates from the inner surface of the structure, where the shrunk first material contains the separated second material because the shrinking of the first material pulls the second material away from the structures' internal surface since the second material is bonded to the first material. The second material (e.g. a release agent) may be removed after the first material has been placed within the structure and prior to an electropolishing or electroplating process. The second material (e.g. a release agent) may be removed after the first material has been shrunk by polymerization or curing or exposure to thermal energy and prior to an electropolishing or electroplating process. The second material may be removed from the inner surface of the structure and/or from the surface of the first material by exposing the second material to for example, a solvent or water, where the second material may be chemically soluble in the solvent or water and thus, flows or is washed away (e.g., by the solvent and/or a fluid such as water or air) from the inner surface of the structure and/or from the surface of the first material. In one or more embodiments, if the second material is coated on a majority or all of the inner surface of the structure and when the first material is placed within the structure and polymerization or curing or exposure to thermal energy of the first material is performed, and due to the polymerization or curing or exposure to thermal energy the first material shrinks and separates away from the inner surface of the structure forming the gaps illustrated in FIG. 3E. Alternatively or additionally, the shrinking of the first material may include the first material separates from the second material. For example, the shrinking of the first material may include separating the second material away from or off of the surface of the first material such that the shrunk first material may or may not contain some of the second material and some of the second material may or may not remain on the inner surface of the structure. Then, the second material may be removed from the inner surface of the structure if the second material was not removed from the inner surface after shrinking of the first material and/or from the surface of the first material by exposing the second material to the above mentioned solvent or water. In one or more embodiments, if the second material is coated only one or more sections/portions of the internal surface of the structure the first material may be placed within the structure and polymerization or curing or exposure to thermal energy of the first material is performed and due to the polymerization or curing or exposure to thermal energy the first material shrinks and moves away from the sections/portions (i.e., sections/portions that do not contain the second material) of the inner surface of the structure forming the gaps illustrated in FIG. 3E. Then, the second material may be removed from the inner surface of the structure if the second material was not removed from the inner surface after shrinking of the first material and/or from the surface of the first material by exposing the second material to the above mentioned solvent or water. As disclosed above, because the structure in FIG. 3E is an example structure, the structure may include an internal volume or the structure may include one or more internal volumes and/or one or more passageways and/or one or more on channels. Thus, there may be more or less gaps than illustrated in FIG. 3E. The first material may include a polymer or a monomer or oligomer such that when the first material undergoes polymerization or is cured or is exposed to thermal energy forms an adhesive and shrinks in volume. For example, methyl methacrylate may have a shrinkage of 25% by volume during a curing process and shrinkage of Nylon12 may be about 4.7% by volume during a curing process. Also, UV cured monomers, such as trimethyloyl propane triacrylate, shrink almost 29% by volume during the curing process. The second material may be a release agent. The release agent may adhere better (e.g., have a large surface tension) to the first material than to the surface of the structure. The release agent may be a thin layer or a uniform thin layer that does not bond to the inner surface of the structure but may bond to the first material.

In one or more embodiments, a voltage can be applied across the gap, such as described the process illustrated in FIG. 4. FIG. 3F illustrates more details of the apparatus, system and process for electropolishing or electroplating the surface of the structure. Structure 300b includes an electrically conductive part 309 coupled to the shrunk first material 307, a nonelectrically conductive part 308 coupled to the electrically conductive part and the structure, and a power source 310 coupled to the electrically conductive part and the structure. Structure 300b further illustrates gap 306 between the shrunk first material and the internal surface of the structure. The power source provides a potential difference between the electrically conductive part and the structure such that a voltage is applied across the gap. For example, to electropolish the internal surface of the structure, the power source creates a potential difference between the electrically conductive part and the structure such that the electrically conductive part is functioning as a cathode and the structure is functioning as an anode, thus applying a voltage across the gap. If the internal surface of the structure is to be electroplated, then the power source creates a potential difference between the electrically conductive part and the structure such that the electrically conductive part is functioning as an anode and the structure is functioning as an cathode, thus applying a voltage across the gap. During an electropolishing process and an electroplating process, a processing media such as a fluid (e.g., a liquid, which may include a mixture of fluids) may be within the gap. The electrically conductive part and/or the nonelectrically conductive part may perform the function of controlling the gap between the first material and the surface of the structure. For example, the electrically conductive part coupled to the shrunk first material enables the shrunk first material to be moved away, preventing from contacting and maintaining a distance away from the surface of the structure. The nonelectrically conductive part may also control the gap between the first material and the surface of the structure by positioning the nonelectrically conductive part on or within the structure such that the shrunk first material is positioned to a desired distance away from the surface of the structure, preventing the shrunk first material from contacting the surface of the structure and maintaining a distance away from the surface of the structure due to the nonelectrically conductive part being also coupled to the electrically conductive part, which is coupled to the shrunk first material. The electrically conductive part may be coupled to the center or centroid of the first material or the shrunk first material to provide a uniform electrical field through the gap and when performing the electropolishing or electroplating process. The electrically conductive part may include a metal or an alloy or other known or equivalent electrically conductive material. In one or more embodiments, the electrically conductive part may include one or more wires. The one or more wires include a metal or an alloy or other known or equivalent electrically conductive material. In one or more embodiments, the electrically conductive part may be a wire inserted into the shrunk first material or inserted into the first material before the first material is shrunk. In one or more embodiments, the electrically conductive part may include two wires, where one wire in coupled to a first end of the first material or the shrunk first material and a second wire is coupled to a second end of the first material or the shrunk first material. The nonelectrically conductive part may include rubber, ceramics, plastics, wood, fiberglass or other known or equivalent nonelectrically conductive material. The nonelectrically conductive part may include a plurality of connected elements or a single element. For example, the nonelectrically conductive part may include a plurality of plastic elements connected together and ends of two of the plastic elements may be fastened to the structure with an adhesive or screws or rivets or a combination thereof or other known fastening devices and ends of one or two other plastic elements may be fastened to the electrically conductive part with an adhesive or screws or rivets or a combination thereof or other known fastening devices.

After the internal and/or external surfaces of the structure have been electropolished or electroplated, the electrically conductive part, the nonelectrically conductive part and the shrunk first material may be removed manually, chemically or robotically from the structure. For example, the nonelectrically conductive part may be decoupled/defastened from the structure. The electrically conductive part and the shrunk first material may be removed from the structure by dissolving or melting the shrunk first material and then washing out with a solvent, a chemical agent, water or other fluid the dissolve or melted first material and the electrically conductive part from the structure. For example, methyl methacrylate melts/burns at 450° C. and polyvinyl chloride (PVC) degrades about 250° C. Also, the chemical agent may be used to breakdown the connecting bonds and allow for easy dissolution of the first material such as a polymer. For example, siloxane based polymers can be fragmented into smaller components by action of acids and bases. Another example of polymer breakdown is available in nature through breakdown of carbohydrates, proteins, and lipids by enzymes.

FIG. 4 is a flowchart illustrating an example process 400 of performing a finishing process on surfaces of a structure in accordance with the apparatuses, systems and methods described herein. The example process may be implemented on a 3D printed structure, for example, a structure printed using an example 3-D printer system, for example a 3-D printer system may be the PBF system 100 discussed in FIGS. 1A-1E. Some aspects may be implemented using other tools, systems, or devices, as is discussed herein.

Block 401 is optional and thus, optionally the method may applying a second material to the surface of the structure such that the second material contacts the structure. If the second material is applied to the surface of the structure, the second material may be manually or robotically or a combination thereof placed within the structure such as within the internal volume and/or the passageway and/or one or more of the internal channels of the structure. The second material may fully coat the internal surface of the structure or portions of the internal surface of the structure. When placing the second material within the structure, the second material may be in the form/state such that the second material may fully coat the internal surface of the structure. For example, the second material may be in the form of a liquid and placed within the internal volume and thus the second material may fully coat the internal surface of the structure. Also, the second material may be in the form of a liquid and placed within select portions within the structure and thus the second material may coat only the selected portions of the internal surface of the structure. In one or more embodiments, coating the second material on the inner surface may include immersing the structure in a solvent containing the second material, draining excess liquid from the structure, and removing (e.g., by evaporating) residual solvent such that the second material coats the inner surface of the structure. The second material may include a release agent, where the release agent is configured to ensure proper release from the first material (e.g. an adhesive) and/or from the structures' surface. In one or more embodiments, the second material may aid the first material in separating from inner surface during shrinking. For example, in one or more embodiments the second material may bond to the first material, and when the first material shrinks (as shown and disclosed below in FIG. 3E), the second material separates from the inner surface of the structure, and second material may pull away from the inner surface with the shrunk first material. In one or more embodiments, second material may bond to the inner surface, and when the first material shrinks (as shown and disclosed below in FIG. 3E), the first material separates from the second material, and second material may stay attached to the inner surface while the first material pulls away. In one or more embodiments, the second material may coat only one or more sections/portions of the internal surface of the structure. For example, the second material may be placed within the internal volume and/or the passageway and/or one or more of the internal channels of the structure. And due to the placing of the second material within the structure and/or the form/state of the second material and/or the shape of internal surface, the second material may coat only one or more sections/portions of the internal surface of the structure. For example, the second material may be placed within the internal volume and the second material may be in the form of a liquid and due to the shape of the surface of the internal volume, the second material only coats the internal volume portion of the internal surface of the structure.

At block 402, the method may include placing a first material within an internal volume of a structure. The first material may be manually or robotically or a combination thereof placed within one or more internal volumes, such as one or more passageways, one or more on channels, etc., of the structure. Placing the first material within the structure may include contacting the first material with the full internal surface of the structure or may contact only one or more sections/portions of the internal surface of the structure. In one or more embodiments, the first material may be in the form of a liquid and placed within (e.g., poured into) the internal volume. In one or more embodiments, due to the placing of the first material within the structure and/or the form/state of the first material and/or the shape of internal surface, the first material may contact only one or more sections/portions of the internal surface of the structure. For example, the first material may be placed within the internal volume and the first material may be in the form of a liquid and due to the shape of the surface of the internal volume, the first material only contacts the internal volume portion of the internal surface of the structure.

At block 404, the method may include shrinking the first material such that a gap is formed between the first material and a surface of the structure. Once the first material is placed within the structure, the first material is shrunk to form a gap between the internal surface of the structure and the first material. In one or more embodiments, shrinking the first material may include curing the first material. In one or more embodiments, curing the first material may include curing with EM radiation (e.g., ultraviolet light), curing with additional material (e.g., a two-part adhesive), curing with heat, etc. In one or more embodiments, shrinking the first material may include applying thermal energy to the first material. For example, the first material shrinks when cured and/or thermally exposed and when the first material shrinks (i.e. cured and/or thermally exposed) the shrunk first material separates from the inner surface of the structure forming the gap between the first material and the internal surface of the structure enabling electropolishing or electroplating of the structure's internal surface.

At block 403, the method may optionally include controlling the gap between the first material and the surface of the structure. In one or more embodiments, controlling the gap may include coupling an electrically conductive part to the first material. In one or more embodiments, controlling the gap may include coupling a nonelectrically conductive part to the structure and to an electrically conductive part. In one or more embodiments, coupling the electrically conductive part to the first material may include inserting the electrically conductive part into the first material such that the electrically conductive part lies within more than half of a length of the first material. In one or more embodiments, coupling the electrically conductive part to the first material may include coupling a first wire of the one or more wires to a first end of the first material and coupling a second wire of the one or more wires to a second end of the first material. In one or more embodiments, placing the first material within the internal volume of the structure may include contacting the first material with the surface of the structure.

At block 405, the method may include applying a voltage across the gap. In one or more embodiments, applying a voltage across the gap may include an electropolishing process. For example, the gap may be filled with an acidic electrolyte bath, and the applied voltage can create an electropolishing of the inner surface. In one or more embodiments, applying a voltage across the gap may include an electroplating process. For example, the gap may be filled with an electrolytic solution with metal salts, and the applied voltage can create an electroplating of the inner surface.

At block 406, the method may optionally include removing at least the first material from the internal volume of the structure. For example, after the internal and/or external surfaces of the structure have been electropolished or electroplated, the electrically conductive part, the nonelectrically conductive part and the shrunk first material may be removed manually, chemically or robotically or a combination thereof from the structure. For example, the nonelectrically conductive part may be decoupled/defastened from the structure. The electrically conductive part and the shrunk first material may be removed from the structure by dissolving or melting the shrunk first material and then washing out with a solvent, a chemical agent, water or other fluid the dissolve or melted first material and the electrically conductive part from the structure.

It is understood that the method illustrated by FIG. 4 is exemplary in nature and that the steps described herein may be combined or modified with other disclosed processes and methods to generate alternative embodiments.

The first material in any of the disclosed embodiments may include adhesive type materials as provided in below Table 1.

TABLE 1

| Adhesive Type | Example Products/Formulations | Shrinkage (Volumetric) |
|---|---|---|
| Epoxies (filled) | EP30LTE-LO, EP30-2, EP30-1NV | Low (0.1-3% volumetric) |
| Epoxies (unfilled) | EP21TCHT-1, EP30 | Moderate (2- |
| | | 5% volumetric) |
| Acrylics (MMA, 2-part) | General 2-part MMA adhesives | Moderate (2-6%) |
| Cyanoacrylates | Commercial super glues | High (4-10%) |
| UV-Curing Adhesives | UV22DC80-10F, Dymax light- | Low to moderate (1-5%) |
| | curable adhesives | |
| High Shrinkage Adhesives | Snap/fast/high-temperature epoxies, | High (>5-10%) |
| | cyanoacrylates | |
| Silicones/Polyurethanes | Dimensionally stable silicone adhesives | Low to moderate (1-6%) |

The first material in any of the disclosed embodiments may include forming an adhesive from the adhesive type materials in Table 1 and from other materials that may include polymers, monomers and oligomers such as siloxane based polymers, methyl methacrylate, trimethyloyl propane triacrylate, polyvinyl chloride (PVC), Nylon12, etc. The first material may include one or more additives such as an electrically or thermally conductive material in order to increase the electrical and/or thermal conductivity of the first material and/or to control the volume of shrinkage of the first material. For example, metal particles such as silver or other electrically conductive particles may be added to the first material to increase the electrical conductivity and to control the volume of shrinkage of the first material. Additionally or alternative, polyaniline may be added to the first material to increase the electrical conductivity of the first material. Also, the first material in the cured and uncured state may have the property to remain in place. The first material may include an adhesive in a cured state and/or an uncured state.

In any of the disclosed embodiments, shrinking of the first material may include polymerization, curing and thermal energy treatment of the first material. Curing may include ultraviolet (UV) radiation curing, heat curing, mixing two materials/components together such as combining two epoxies, delayed curing such as light initiation or by other curing methods and energies. Thermal energy treatment may include applying thermal energy to the first material such that the first material undergoes a cycle from a high temperature to a low temperature. This phenomenon may lead to much smaller volume changes than curing of monomers and may take advantage of the coefficient of thermal expansion (CTE) of uncured materials by solidifying materials. Such materials may be based on waxes or other meltable chemicals.

The release agents in any of the disclosed embodiments may include silicone-based compounds such as polydimethylsiloxane including Dow Corning 111 and GE Silicone Release SPR=200, wax based and fatty ester agents such as magnesium stearate or Boeing wax, and fluorinated based release agents such as fluorosilicones or polytetrafluoroethylene (PTFE) including Chemours Teflon, and Whitford Xylan.

In any of the disclosed embodiments, the structure may include a metal, an alloy such as an aluminum, nickel or titanium alloy or other electrically or thermally conductive material.

In any of the disclosed embodiments, the electrically conductive part may include a metal, an alloy such as an aluminum, nickel or titanium alloy or other electrically conductive material.

In any of the disclosed embodiments, the power source may include a battery, a generator, an alternator, fuel cells, galvanic cells, photovoltaic cells, thermocouples, transformers, piezoelectric devices and any other device capable of producing a voltage.

In any of the disclosed embodiments, the process of electropolishing and electroplating includes placing an processing media such as an electropolishing and electroplating fluid within the gap between the surface of the structure and the shrunk first material. For example, the electropolishing and electroplating fluid may be a liquid, which may be a mixture of fluids. In one or more embodiments of the above disclosure, the process of electropolishing and electroplating includes placing the structure in a processing media such as a electropolishing and electroplating fluid such that the processing media is located within the gap between the surface of the structure and the shrunk first material. From the disclosed methods, apparatuses and systems a near mirror finish may be achieved when electropolishing or electroplating the structure's surface. For example, a surface finish less than Ra 10 um may be achieved.

The previous description is provided to enable any person skilled in the art to practice the various aspects described herein. Various modifications to these example embodiments presented throughout this disclosure will be readily apparent to those skilled in the art, and the concepts disclosed herein may be applied to other techniques of finishing and printing structures. Thus, the claims are not intended to be limited to the example embodiments presented throughout the disclosure, but are to be accorded the full scope consistent with the language of the claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method comprising:
placing a first material within an internal volume of a structure;
shrinking the first material such that a gap is formed between the first material and a surface of the structure; and
applying a voltage across the gap.

2. The method of claim 1, wherein shrinking the first material comprises curing the first material.

3. The method of claim 1, wherein shrinking the first material comprises applying thermal energy to the first material.

4. The method of claim 1, wherein applying the voltage comprises an electropolishing process.

5. The method of claim 1, wherein applying the voltage comprises an electroplating process.

6. The method of claim 1, wherein the first material comprises an adhesive.

7. The method of claim 6, wherein the adhesive comprises an electrically conductive adhesive.

8. The method of claim 6, wherein the adhesive comprises one or more electrically conductive elements.

9. The method of claim 8, wherein the one or more electrically conductive elements comprises metallic particles.

10. The method of claim 1, further comprising applying a second material to the surface of the structure such that the second material contacts the first material.

11. The method of claim 10, wherein the second material comprises a release agent.

12. The method of claim 11, wherein the first material separates from the release agent when shrinking of the first material.

13. The method of claim 1, further comprising controlling the gap between the first material and the surface of the structure.

14. The method of claim 13, wherein controlling the gap comprises coupling an electrically conductive part to the first material.

15. The method of claim 14, wherein controlling the gap further comprises coupling a nonelectrically conductive part to the structure and the electrically conductive part.

16. The method of claim 14, wherein coupling the electrically conductive part to the first material comprises inserting the electrically conductive part into the first material such that the electrically conductive part lies within more than half of a length of the first material.

17. The method of claim 14, wherein the electrically conductive part comprises one or more wires.

18. The method of claim 17, wherein coupling the electrically conductive part to the first material comprises coupling a first wire of the one or more wires to a first end of the first material and coupling a second wire of the one or more wires to a second end of the first material.

19. The method of claim 1, wherein placing the first material within the internal volume of the structure comprises contacting the first material with the surface of the structure.

20. The method of claim 19, wherein the first material separates from the surface of the structure when shrinking of the first material.

21. The method of claim 1, further comprising:
removing the first material from the internal volume.

22. The method of claim 21, wherein removing the first material from the internal volume includes at least burning the first material, melting the first material, dissolving the first material, manually removing the first material, automatedly removing the first material, or chemically removing the first material.
